(19) United States
(12) Patent Application Publication
(10) Pub. No.: US 2026/0360981 A1
(43) Pub. Date: Nov. 12, 2026

(54) PARTIALLY HIDDEN LOOP ANTENNA

(71) Applicant: Widex A/S, Lynge (DK)

(72) Inventor: Abdul MUNEER, Lynge (DK)

(73) Assignee: Widex A/S, Lynge (DK)

(21) Appl. No.: 19/486,437

(22) PCT Filed: May 16, 2024
(86) PCT No.: PCT/EP2024/063633

§ 371 Date: Nov. 21, 2025

(30) Foreign Application Priority Data
May 23, 2023 (DK) PA202330040

(51) Int. Cl. H01Q 7/00

(52) U.S. Cl. CPC H01Q 7/00

(57) ABSTRACT

A single-ended loop antenna (20) for transmitting signals in 2.4 GHz is provided. The single-ended loop antenna (20) comprises: a first part comprising a conducting ground plane (21); and a second part comprising a conductor (23) arranged as a single-ended loop in a plane parallel to the ground plane; wherein the second part is longer than λ/6 and smaller than λ, and a first end (24) of the second part is connected to feed and a second end (25) of the second part is electrically connected to the first part; and wherein both the first part and the second part of the antenna (20) are configured to radiate signals. A hearing aid (10) comprising such an antenna (20) is further provided.

### TECHNICAL FIELD

The present inventive concept relates to a single-ended loop antenna and a hearing aid comprising such. More specifically, the present inventive concept relates to a single-ended loop antenna comprising a hidden part and a visible part.

### BACKGROUND

Loop antennas for transmitting signals in 2.4 GHz are known. However, these antennas have a relatively fixed size and placement restrictions, which limits their use in size-restricted devices, such as hearing aids and especially in-the-ear type (ITE) hearing aids.

### SUMMARY

It is thereby an object of the present inventive concept to create a loop-type antenna that is smaller than conventional loop-type antennas without sacrificing too much efficiency. This and other objects are achieved by the features set out in the appended independent claims, with embodiments set out in the dependent claims.

Accordingly, a first aspect of the inventive concept is provided by a single-ended loop antenna for transmitting signals in 2.4 GHz. The single-ended loop antenna comprises: a first (hidden) part comprising a conducting ground plane; and a second (visible) part comprising a conductor arranged as a single-ended loop in a plane parallel to the ground plane. The second part is longer than λ/6 and smaller than λ, and a first end of the second part is connected to feed and a second end of the second part is electrically connected to the first part. Both the first part and the second part of the antenna are configured to radiate signals.

Such a loop antenna makes the ground plane of the antenna part of the radiating part of the antenna, which frees up space where the second part would otherwise extend the full length of λ. This does not meaningfully affect the performance and efficiency of the antenna, while reducing the size of the second part of the antenna. The bandwidth may be slightly reduced; however, this is an acceptable trade-off for many embodiments.

Since the conductor of the second part of the antenna is connected to feed and the first part of the antenna and both the first and second part of the antenna are conducting, both the first and second part of the antenna will radiate signals when the antenna is fed.

Using the ground plane as a radiating part has further benefits, in that a robustness of the antenna is increased compared to a conventional loop antenna.

This is because a current in the first part of the antenna is spread out over a larger area than e.g. a 1 mm wide wire, so the current is less susceptible to a disturbance.

It is noted that the ground plane may not be connected to ground and/or feed and may be called a conducting plane or a reflecting plane. A ground plane for antenna purposes has nothing to do with electrical grounding.

For the sake of understanding, the first part of the antenna may be called the hidden part since it blends in with the printed circuit board of the rest of the device even though it is clearly visible, and the second part of the antenna may be called the visible part since it clearly stands out as e.g. a wire or metal strip. It is noted that in most devices the (whole) antenna will be hidden behind a shell to avoid user disruptions and as such both parts are in effect hidden, and these terms are merely monikers for the sake of differentiation and understanding.

The ground plane may be part of a printed circuit board. This further simplifies integration of the antenna and enables an even smaller footprint of the antenna. This enhances the already present benefit of a smaller size antenna.

The conductor may be a metal wire or a metal sheet. These have well-known characteristics in the field and perform well as radiation sources.

The conductor may be manufactured using laser direct structuring (LDS). This greatly streamlines a manufacturing process, in that LDS is reliable and fast compared to similar methods of manufacturing.

The conductor may be shaped as a circle arc larger than π radiance and smaller than 3π/2 radiance. Such a shape will radiate effectively and is smaller than conventional circle-shaped loop antennas.

The visible part may further comprise lump components in physical contact with the conductor. Such lump components may e.g. be capacitors and/or inductors used to tune the antenna.

The visible part may only in physical contact with the ground plane at the first and second ends of the visible part. This simplifies manufacturing and may improve radiation characteristics in certain embodiments.

The conductor may be arranged in the same plane as the ground plane. Such an arrangement may be especially size-efficient and/or easy to manufacture in certain embodiments.

The conductor may be arranged above the ground plane. Such an arrangement may be especially size-efficient and/or easy to manufacture in certain embodiments.

According to a second aspect of the invention, a hearing aid comprising the antenna according to the first aspect is provided. All modifications and improvements to the first aspect apply mutatis mutandis to the second aspect.

The hearing aid is an in-the-ear (ITE) hearing aid. Such a hearing aid is especially size-restricted, and would thereby particularly benefit from the reduced size of the antenna.

The hidden part of the antenna may be oriented towards a tragus of a user when in use. The tragus may interfere with the function of conventional loop antennas and may thereby affect the optimal placement of the antenna in the hearing aid. As the hidden part of the antenna is especially robust compared to a conventional loop antenna, by this orientation, the antenna may be positioned closer to the tragus than otherwise possible, improving performance and enabling different, more optimal placements of the antenna within the hearing aid.

A printed circuit board of the hearing aid may be the ground plane of the antenna and comprise at least one component placed directly in a path through the printed circuit board between the first and second end of the visible part of the antenna.

Using a conventional loop antenna, such a placement of said at least one component may be blocked by the loop antenna. As the present inventive concept comprises a hidden part, this portion of the printed circuit board may be used when placing (large) components, thereby further enabling different, more optimal hardware designs and a reduction of a total size of the hearing aid.

### DESCRIPTION OF DRAWINGS

The invention will be described in further detail with reference to preferred aspects and the accompanying drawing, in which:

FIGS. 1a-b show different schematic views of an antenna according to an embodiment;

FIGS. 2a-b show different schematic views of an antenna according to an embodiment;

FIGS. 2a-b show different schematic views of an antenna according to an embodiment;

FIGS. 3a-b shows different schematic views of a hearing aid according to an embodiment; and

FIG. 4 shows a schematic view of a hearing aid according to an embodiment being used.

### DESCRIPTION OF EMBODIMENTS

In the following, terms such as a/an/the and comprising are intended to be interpreted as non-limiting. Any processor or computing unit may be implemented as an electronic circuit and electronic connections may be wired or wireless unless otherwise explicitly stated. Unless explicitly specified, a wireless connection may be implemented in any number of standards known to a person skilled in the art, such as Wi-Fi, Bluetooth®, Zigbee, 4G/LTE, 5G and so one.

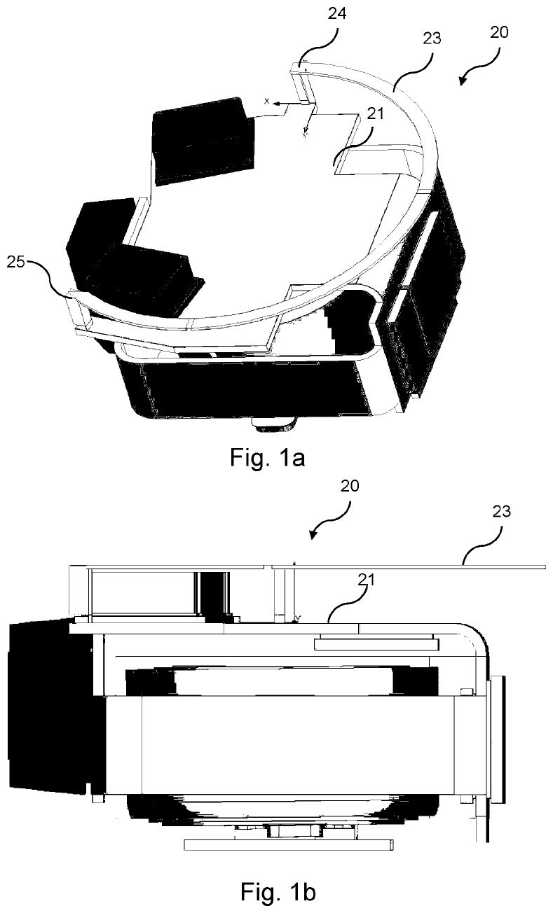

FIG. 1a shows an embodiment of a single-ended loop antenna 20. The antenna 20 is a Bluetooth® antenna, i.e. it has a size such that it is configured to transmit signals in 2.4 GHz. The antenna 20 comprises a hidden part and a visible part. Both the hidden part and the visible part of the antenna 20 are configured to radiate signals

The hidden part comprises a conducting ground plane 21. The ground plane 21 in FIG. 1a is part of a printed circuit board, however other ground planes are also possible.

The visible part comprises a conductor 23 arranged as a single-ended loop in a plane above the ground plane 21 of the hidden part. The conductor 23 is made of metal, such as copper or gold, and may be made of a metal alloy. The conductor 23 may be a wire or sheet. The conductor 23 may be manufactured using laser direct structuring (LDS).

The conductor 23 is shaped as a circle arc larger than π radiance and smaller than 3π/2 radiance.

The visible part is longer than λ/6 and smaller than λ, and a first end 24 of the visible part is connected to feed and a second end 25 of the visible part is electrically connected to the hidden part.

Components are placed directly in a path through the hidden part between the first and second ends 24, 25 of the visible part of the antenna 20. These components would not fit using a conventional loop antenna, as is further clarified by the view in FIG. 1b.

FIG. 1b shows a side view of the antenna embodiment of FIG. 1a. In this view, it is clear that the visible part is only in physical contact with the ground plane 21 at the first and second ends of 24, 25 the visible part.

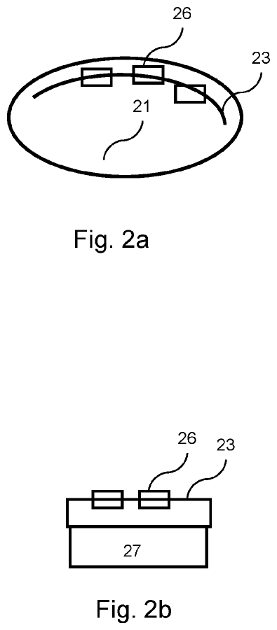

FIGS. 2a-b show an embodiment of a single-ended loop antenna 20. Compared to the embodiment of FIGS. 1a-b, the visible part in FIGS. 2a-b further comprises lump components 26 in physical contact with the conductor 23.

The lump components 26 may be capacitors or inductors. The lump components may be configured to tune the impedance of the antenna 20 to match the rest of the circuit, which is usually around 50 Ohm.

By fine-tuning the impedance of the antenna 20 using lump components 26 the radiation efficiency is improved.

FIG. 2a shows the antenna 20 from a top view, and FIG. 2b shows the antenna from a side view. FIG. 2b further shows a battery 27.

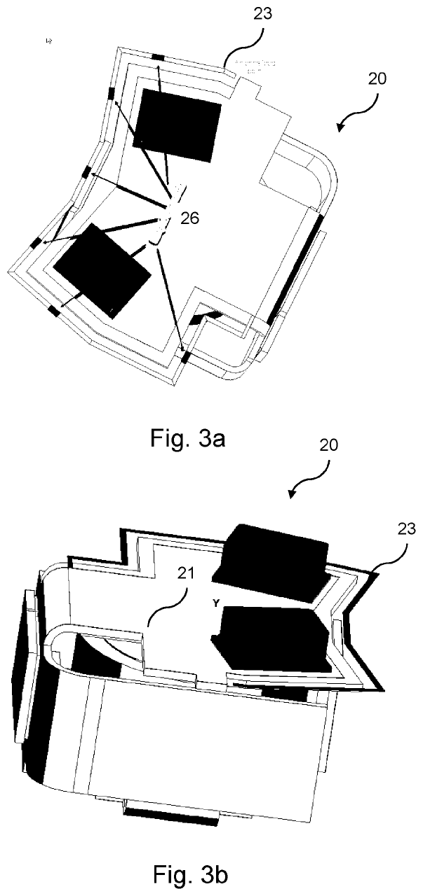

FIGS. 3a-b show an embodiment of a single-ended loop antenna 20. Compared to the embodiment of FIGS. 1a-b, the visible part in FIGS. 3a-b is arranged in the same plane as the ground plane 21. Furthermore, the conductor 23 is not shaped as a circle arc in FIG. 3, but instead has an open, angular loop shape where the first and second ends 24, 25 of the visible part has a relatively significant distance between each other to define the hidden part.

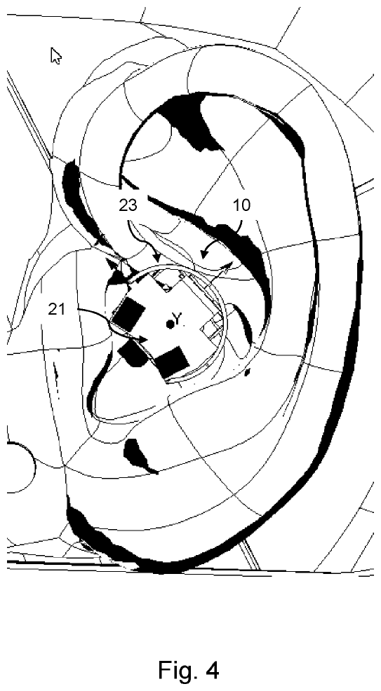

FIG. 4 shows an in-the-ear hearing aid 10 comprising a single-ended loop antenna 20. The single-ended loop antenna 20 of FIG. 4 may be replaced with any of the embodiments discussed herein.

The hidden part of the antenna 20 in FIG. 4 is oriented towards a tragus of a user. This improves the reliability and performance of the antenna compared to other orientations.

The preceding description has been a non-exhaustive disclosure of different exemplifying embodiments of the present inventive concept. This is not to be misconstrued as limiting the scope of the protection sought for the inventive concept, which is defined by the appended claims.

1: A single-ended loop antenna for transmitting signals in 2.4 GHz comprising:
a hidden part comprising a conducting ground plane; and
a visible part comprising a conductor arranged as a single-ended loop in a plane parallel to the ground plane;
wherein the visible part is longer than λ/6 and smaller than λ, and a first end of the visible part is connected to feed and a second end of the visible part is electrically connected to the hidden part; and
wherein both the hidden part and the visible part of the antenna are configured to radiate signals.

2: The antenna according to claim 1, wherein the ground plane is part of a printed circuit board.

3: The antenna according to claim 1, wherein the conductor is a metal wire or a metal sheet.

4: The antenna according to claim 1, wherein the conductor is manufactured using laser direct structuring, LDS.

5: The antenna according to claim 1, wherein the conductor is shaped as a circle arc larger than π radiance and smaller than 3π/2 radiance.

6: The antenna according to claim 1, wherein the visible part further comprises lump components in physical contact with the conductor.

7: The antenna according to claim 1, wherein the visible part is only in physical contact with the ground plane at the first and second ends of the visible part.

8: The antenna according to claim 7, wherein the conductor is arranged in the same plane as the ground plane.

9: The antenna according to claim 1, wherein the conductor is arranged above the ground plane.

10: A hearing aid comprising the antenna according to claim 1.

11: The hearing aid according to claim 10, wherein the hearing aid is an in-the-ear, ITE, hearing aid.

12: The hearing aid according to claim 11, wherein the hidden part of the antenna is oriented towards a tragus of a user when in use.

13: The hearing aid according to claim 10, wherein a printed circuit board of the hearing aid is the ground plane of the antenna and comprises at least one component placed directly in a path through the printed circuit board between the first and second ends of the visible part of the antenna.
